(19) United States
(12) Patent Application Publication
(10) Pub. No.: US 2016/0330234 A1
(43) Pub. Date: Nov. 10, 2016

(54) Secure Coding Framework Based on Cyber Security through Lexical and Symbolic Proxy Technology

(71) Applicant: Stephen T. Kertis, McCordsville, IN (US)

(72) Inventor: Stephen T. Kertis, McCordsville, IN (US)

(21) Appl. No.: 15/149,311

(22) Filed: May 9, 2016

Related U.S. Application Data
(60) Provisional application No. 62/159,250, filed on May 9, 2015.

(51) Int. Cl. H04L 29/06; G06F 9/44

(52) U.S. Cl. CPC H04L 63/1441; G06F 8/30; H04L 63/0281; H04L 63/101

(57) ABSTRACT

The Secure Coding Framework (“SCF”) is a class library that wraps and replaces cyber-vulnerable primitives and operators of the underlying programming language used by the developer with secure classes and methods of its class library. The SCF is able to detect and thwart cyber attacks in a policy-based manner.

### CROSS-REFERENCE TO RELATED APPLICATIONS

This application claims priority to and the benefit of U.S. Provisional Application No. 62/159,250 filed on May 9, 2015.

### REFERENCE TO COMPUTER PROGRAM LISTING IN APPENDIX A

Listing #1(a)—the SecureInteger class

Listing #1(b)—the SecureFloat class

Listing #1(c)—the SecureByte class

Listing #2—the SecureIntegerArray class

Listing #3—the SecureIntegerRange class

Listing #4—the SecureString class

Listing #5—the SecureDimension class

Listing #6—the SecureMultiDimension class

Listing #7—the SecureCodingException class

Listing #8—the SecureExceptionLogger class

Listing #9—the SecureExceptionManager class

Listing #10—the SecureExceptionTypes class

Listing #11—the SecureRangeChecking class

Listing #12—the SecurityPolicy class

Listing #13—the SecureArrayIndex class

Listing #14—the SecureArrayIndexRange class

### BACKGROUND OF THE INVENTION

The secure coding framework (SCF) is a software development tool that enables the construction of secure code. It is a response to the growing crisis in cybersecurity breaches, many of which prey on weaknesses in application code running on servers. The approach of SCF is rather unique in that it builds software that is self-protecting. It does not need protection from its boundaries. It is protected from within. It can detect attacks and react in a policy-driven fashion to thwart those attacks.

The current method of developing secure code is to write functional code, pass it through one or more static and/or dynamic analysis tools to identify all instances of cyber vulnerabilities, and then remedy the offending code in accordance with a secure coding standard. Most such standards would be based on the Software Engineering Institute (SEI) Secure Coding Standard.

The innovative approach, using SCF, is to replace the vulnerable aspects of the underlying programming language with a secure classes and methods as proxies. The secure proxies are constructed with built-in remedies to vulnerabilities from the SEI Secure Coding Standard. The SEI Secure Coding Standard presently supports C, C++, Java and Perl. For those languages that are not supported by the SEI, implementation would need to follow a parallel logic and provide language agnostic remedies to vulnerabilities identified in the Common Weakness Enumeration (CWE) and Open Web Application Security Project (OWASP). It should be noted that SCF does not support the C programming language as it is not object-oriented. Only the classes and methods of the SCF use vulnerable primitives and operators and they do so in a secure manner. Application developers do not use primitives and operators, but rather they use the secure classes and methods of SCF as proxies. SCF does not just remove instances of vulnerabilities from code, but it eliminates entire classes of vulnerabilities from code. By using SCF, it is nearly impossible to introduce covered cyber vulnerabilities into the source code.

### SUMMARY OF THE INVENTION

The SCF is a software framework that enforces CLaSP technology. The CLaSP technology transforms vulnerable object-oriented programming languages into a programming platform for developing secure software. The SCF supports the construction of secure code from the ground up. To the greatest extent possible, the solutions that are built-in to the design and implementation of this software are aligned with language-specific remedies for vulnerabilities documented in the Software Engineering Institute (SEI) Secure Coding Standards.

### BRIEF DESCRIPTION OF THE SEVERAL VIEWS OF THE DRAWING

FIG. 1 illustrates the template to follow for construction of the Secure<Primitive>classes.

FIG. 2 illustrates the template to follow for construction of the Secure<Primitive>Array classes.

FIG. 3 illustrates the template to follow for construction of the Secure<Primitive>Range classes.

FIG. 4 illustrates the template to follow for construction of the SecureString classes.

FIG. 5 illustrates the template to follow for construction of the SecureDimension class.

FIG. 6 illustrates the template to follow for construction of the SecureMultiDimension class.

FIG. 7 illustrates the template to follow for construction of the SecureCodingException class.

FIG. 8 illustrates the template to follow for construction of the SecureExceptionLogger class.

FIG. 9 illustrates the template to follow for construction of the SecureExceptionManager class.

FIG. 10 illustrates the template to follow for construction of the SecureRangeChecking class.

FIG. 11 illustrates the template to follow for construction of the SecureArrayIndex class.

FIG. 12 illustrates the template to follow for construction of the SecureArrayIndexRange class.

### DETAILED DESCRIPTION OF THE INVENTION

For the purposes of promoting an understanding of the principles of the invention, reference will now be made to the embodiments illustrated in the drawings and specific language will be used to describe the same. It will nevertheless, be understood that no limitation of the scope of the invention is thereby intended. Any such alterations and further applications of the principles of the invention as illustrated herein are contemplated as would normally occur to one skilled in the art to which the invention relates.

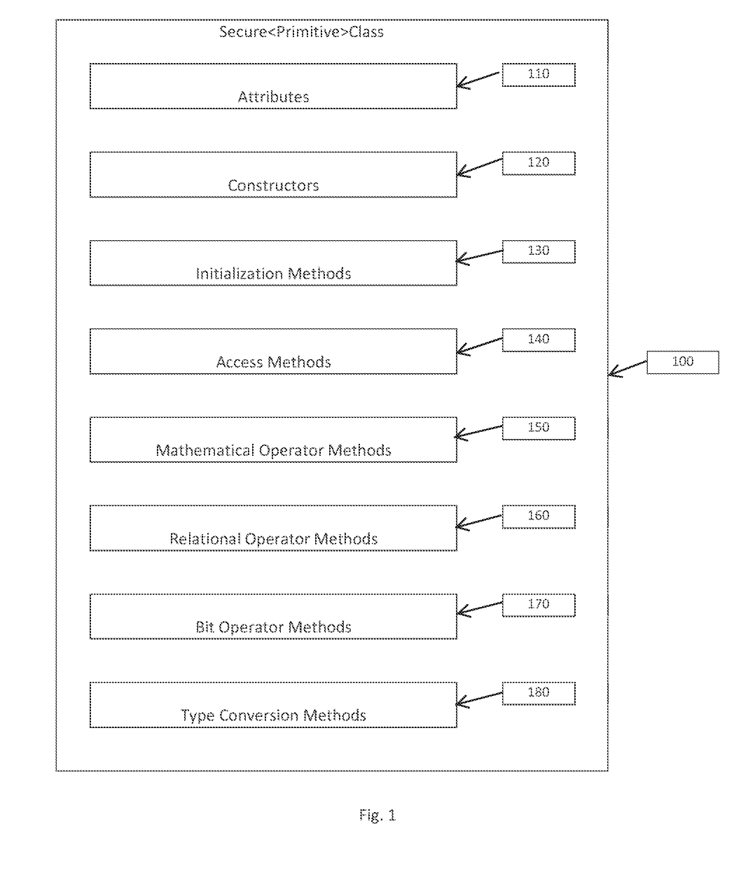

In FIG. 1, a template is provided for guidance in the implementation of the secure classes that serve as a proxy for the primitives of the underlying programming language. The template applies to each and every primitive of the programming language. If, for example, the Java programming language was selected as the underlying programming language, then the template must be used to create one class for each primitive of Java including: (a) char; (b) byte; (c) short; (d) int; (e) long; (f) float; and (g) double. The result would be construction of the following secure classes: (a) SecureCharacter; (b) SecureByte; (c) SecureShort; (d) SecureInteger; (e) SecureLong; (f) SecureFloat; and (g) SecureDouble. It should be appreciated that the disclosure of the Java programming language is for illustrative purposes only and that the invention is applicable to all programming languages and would vary per programming language.

Each of the newly constructed secure classes would follow the template in accordance with the elements of FIG. 1. As stated above, the list of primitives will vary from language to language. The intent of this patent is to create a language agnostic approach to the construction of the SCF.

### Secure <Primitive>

The template of FIG. 1 shows that the Secure<Primitive> class 100 contains attributes and methods including: (a) value attribute 110; (b) range attribute 120; (c) constructors and initialize methods 130; (d) access methods 140; (e) mathematical operator methods 150; (f) relational operator methods 160; (g) bit operator methods 170; and (h) type conversion methods. This class is used to securely replace primitives of the underlying programming language. The presence of this class and compliance with its specification (or its functional equivalent) is a primary component of the SCF. Primary components serve as proxies for primitives.

The presence of this class and compliance with its specification (or its functional equivalent) is a mandatory requirement of the SCF.

The attributes 110 include: (a) a primitive value; and (b) a range expressed as an instance of the Secure<Primitive>Range class. The attributes 110 must be private. By making the attributes 110 private, the SCF uses the concept of data hiding to protect data values from corruption. By design, these data values can only be set using methods of the class.

The constructors 120 provide declarations and initializations of attributes 110. Constructors must always be public. Constructors are expected to leverage the initialization methods 130 in their implementations.

The initialization methods 130 provide default and/or user-defined settings for attributes 110. Initialization methods are generally public. These methods are also used by the constructors 120.

The access methods 140 must provide getters and setters for attributes 110. The access methods 140 must be public. The setters must perform range checking before assignments to the primitive value of attributes 110. Exception handlers must be triggered when an attempt to assign values outside of the valid range are detected. However, constructors may not trigger exceptions.

The mathematical operator methods 150 must be provided for each and every mathematical operator of the underlying programming language. The mathematical operator methods 150 must be public.

The relational operator methods 160 must be provided for each and every relational operator of the underlying programming language with the exception of the Boolean operator. Since the Boolean operator has only two values, it is considered to be secure. It does not need a secure proxy. The relational operator methods 160 must be public.

The bit operator methods 170 must be provide for each and every bit operator of the underlying programming language. The bit operator methods 170 must be public. While bit operator methods 170 are applicable to integer primitives, they are not applicable to floating point primitives.

The type conversion methods 180 must be provided for typecasting to each and every Secure<Primitive> where such type conversions are valid. The decision is as to whether or not a typecast is valid left to the implementer. A good rule of thumb to follow is that widening typecasts are valid and narrowing typecast are not valid. The type conversion methods 180 must be public.

Refer to Program Listing #1(a), #1(b) and #1(c) for an example of how this Secure<Primitive>class 100 might be implemented.

### Secure <Primitive> Array

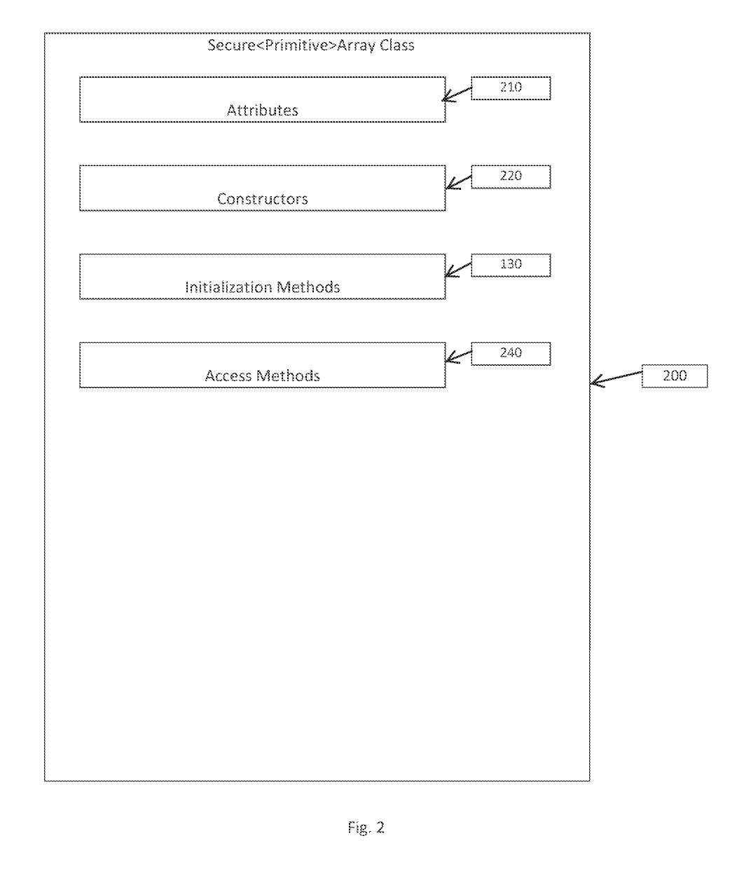

The template illustrated in FIG. 2 shows that the Secure<Primitive>Array class 200 contains attributes and methods including: (a) attributes 210; (b) constructors 220; (c) initialization methods 230; and (d) access methods 240. This class is used to securely replace primitive arrays of the underlying programming language. The presence of this classes and compliance with its specification (or its functional equivalent) is mandatory and a primary requirement of the SCF.

The attributes 210 includes: (a) primitive array; (c) range expressed as an instance of Secure<Primitive>Range; and (c) a dimension expressed as an instance of the SecureMultiDimension class. The attributes 210 must all be private.

The constructors 220 provide declarations and initializations of attributes 210. Constructors 220 must always be public. Constructors 220 are expected to leverage the initialization methods 230 in their implementations.

The initialization methods 230 provide default and/or user-defined settings for attributes 210. Initialization methods 230 are generally public. The initialization methods 230 are also used by the constructors 220.

The access methods 240 must provide getters and setters for attributes 210. The access methods 240 must be public. The setters must perform range checking before assignments to the array value attribute 210. Exception handlers must be triggered when an attempt to assign values outside of the valid range are detected. However, constructors may not trigger exceptions.

Refer to Program Listing #2 for an example of how this Secure<Primitive>Array class 200 might be implemented.

### Secure <Primitive> Range

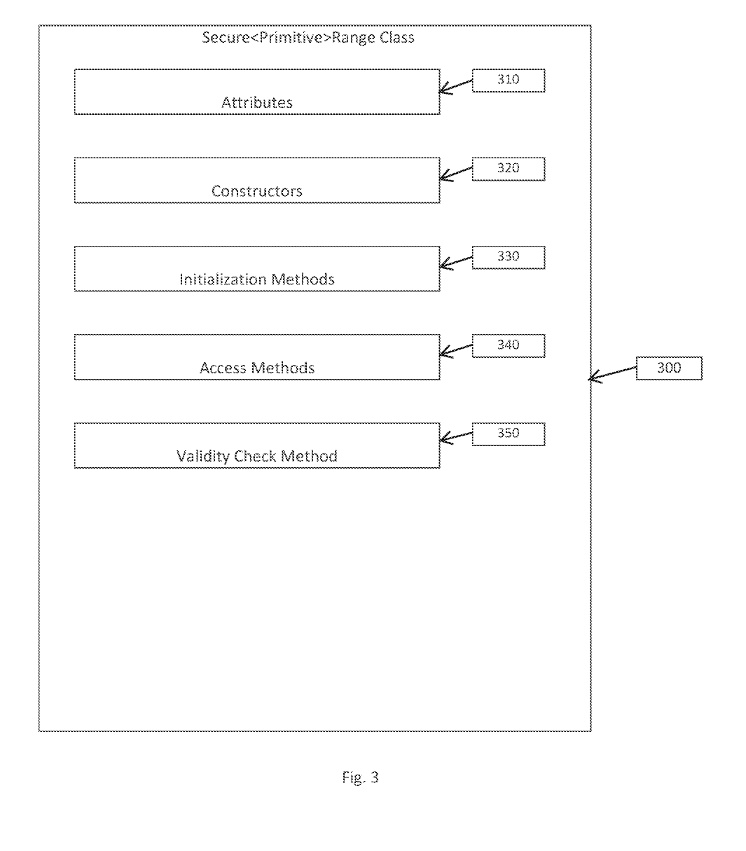

The template illustrated in FIG. 3 shows that the Secure<Primitive>Range class 300 contains attributes and methods including: (a) attributes 310; (b) constructors 320; (c) initialization methods 330; (d) access methods 340; and (e) validity check 350. This class is used to securely represent the valid range of numbers that can be assigned to Secure<Primitives> and indexed elements of Secure<Primitive> Arrays. The presence of this class and compliance with its specification (or its functional equivalent) is mandatory but a secondary component of the SCF. Secondary components provide functional support for primary components.

The attributes 310 include a: (a) primitive user-defined minimum value; and (b) primitive user-defined maximum value: (c) language-specific minimum primitive value; and (d) language-specific maximum primitive value. Items (c) and (d) are constants. The values for these constants represent the lowest and highest number that can be represented in the primitive of the underlying programming language. Therefore these constant values are language dependent.

The constructors 320 provide declarations and initializations of attributes 310. Constructors 320 must always be public. Constructors 320 are expected to leverage the initialization methods 330 in their implementations.

The initialization methods 330 provide default and/or user-defined settings for attributes 310. Initialization methods 330 are generally public. The initialization methods 330 are also used by the constructors 320.

The access methods 340 must provide getters and setters for the range attributes 310. The access methods 340 must be public. The setters must perform range checking before assignments to the range attribute 310. Exception handlers must be triggered when an attempt to assign values outside of the valid range are detected. However, constructors may not trigger exceptions.

The validity check method 350 determines whether or not the user-defined range attributes are valid. Refer to Sequence Listing #3 for an example of how this Secure<Primitive>Range class 300 might be implemented.

### Secure String

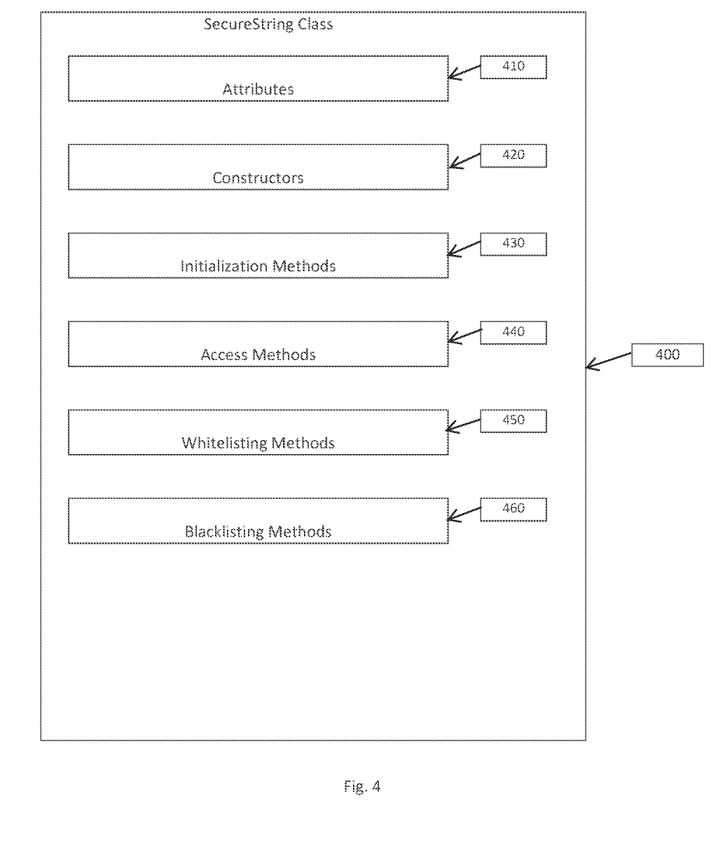

The template illustrated in FIG. 4 shows that the SecureString class 400 contains attributes and methods including: (a) attributes 410; (b) constructors 420; (c) initialization methods 430; (d) access methods 440; (e) whitelisting methods 450; and (f) blacklisting methods 460. This class is used to securely represent strings for specified and well known purposes. For example some strings are used as pathnames or filenames, URL, XML, HTTP, LDAP, SQL statements, etc. The presence of this class and compliance with its specification (or its functional equivalent) is mandatory and a primary component of the SCF. Primary components are proxies for the String class of standard libraries or a primitive character array.

The attributes 410 include: (a) character array (or string); (b) array (or string) size; (c) type of string; (d) the active rule (whitelist or blacklist); (e) character list; and (f) character sequence list.

The constructors 420 provide declarations and initializations of attributes 410. Constructors 420 must always be public. Constructors 420 are expected to leverage the initialization methods 430 in their implementations.

The initialization methods 430 provide default and/or user-defined settings for attributes 410. Initialization methods 430 are generally public. The initialization methods 430 are also used by the constructors 420.

The access methods 440 must provide getters and setters for attributes 410. The access methods 440 must be public.

The whitelisting methods 450 include: (a) whitelist character; and (b) whitelist character sequence. The whitelist is a listing of allowable characters or character sequences in the string.

The blacklisting methods 460 include: (a) blacklist character; and (b) backlist character sequence. The blacklist is a listing of disallowed characters or character sequences in the string.

Refer to Program Listing #4 for an example of how this SecureString class 400 might be implemented.

### Secure Dimension

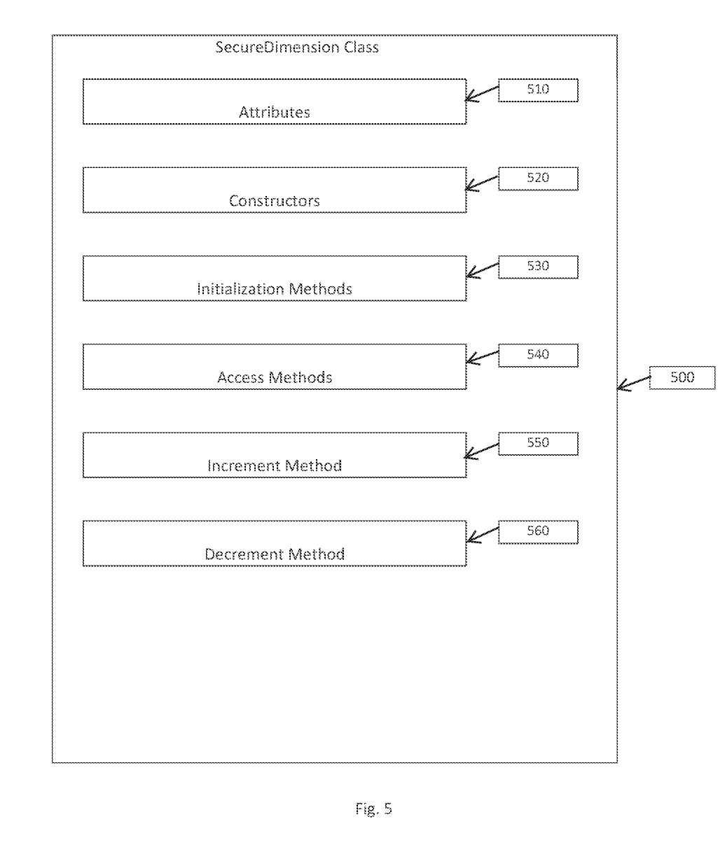

The template illustrated in FIG. 5 shows that the SecureDimension class 500 contains attributes and methods including: (a) attributes 510; (b) constructors 520; (c) initialization methods 530; (d) access methods 540; (e) increment method 550; and (f) decrement method 560. This class is used to securely represent the dimensional aspect of a single dimensional numeric array. The presence of this class and compliance with its specification (or its functional equivalent) is mandatory but a secondary component of the SCF. Secondary components provide functional support for primary components.

The attributes 510 includes: (a) primitive size; and (b) index in the form of an instance of the SecureArrayIndex class.

The constructors 520 provide declarations and initializations of attributes 510. Constructors must always be public. Constructors are expected to leverage the initialization methods in their implementations.

The initialization methods 530 provide default and/or user-defined settings for attributes 510. Initialization methods 530 are generally public. The initialization methods 530 are also used by the constructors 520.

The access methods 540 must provide getters and setters for attributes 510. The access methods 540 must be public.

The increment method 550 increases the index by 1. The index must be within the boundary of the array.

The decrement method 560 decreases the index by 1. The index must be within the boundary of the array.

Refer to Program Listing #5 for an example of how this SecureDimension class 500 might be implemented.

### Secure Multi Dimension

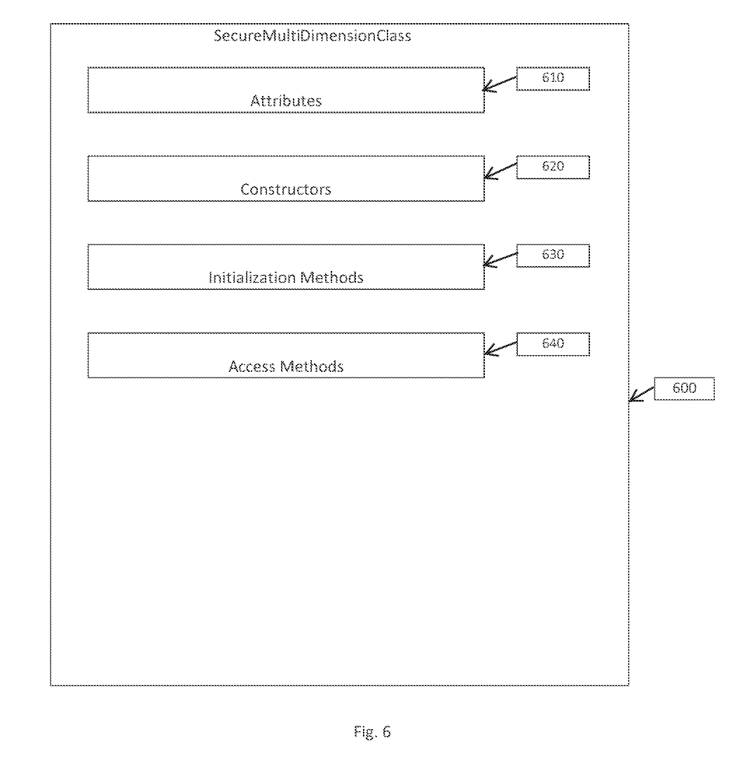

The template illustrated in FIG. 6 shows that the SecureMultiDimension class 600 contains attributes and methods including: (a) attributes 610; (b) constructors 620; (c) initialization methods 630; and (d) access methods 640. This class is used to securely represent the dimensional aspect of a multi-dimensional numeric array. The presence of this class and compliance with its specification (or its functional equivalent) is mandatory but a secondary component of the SCF. Secondary components provide functional support for primary components.

The attributes 610 include: (a) primitive size; (b) primitive number of dimensions; and (c) an array of dimensions expressed as an array of SecureDimension instances; and (d) primitive maximum number of dimensions. Attribute (d) is a constant.

The constructors 620 provide declarations and initializations of attributes 610. Constructors must always be public. Constructors 620 are expected to leverage the initialization methods 630 in their implementations.

The initialization methods 630 provide default and/or user-defined settings for attributes 610. Initialization methods are generally public. The initialization methods 630 are also used by the constructors 620.

The access methods 640 must provide getters and setters for attributes 610. The access methods 640 must be public.

Refer to Program Listing #6 for an example of how this SecureMultiDimension class 600 might be implemented.

### Secure Coding Exception

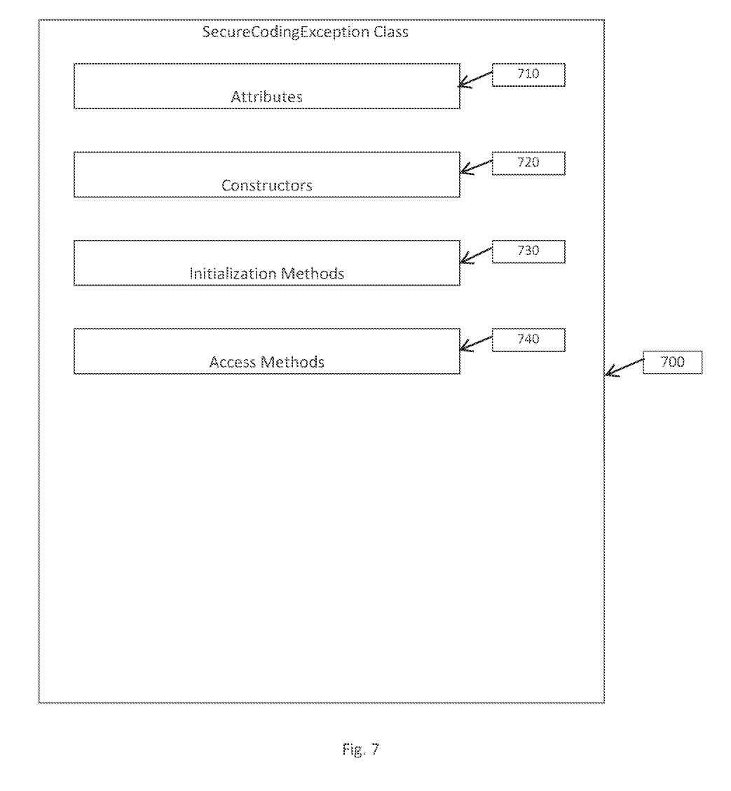

The template illustrated in FIG. 7 shows that the SecureCodingException class 700 contains attributes and methods including: (a) attributes 710; (b) constructors 720; (c) initialization methods 730; and (d) access methods 740. This class is used to securely represent exceptions for specified exception types. For an example some exceptions might indicate an integer overflow or integer underflow, while others might indicate loss of sign, magnitude or precision in floating point operations, etc. The presence of this class and compliance with its specification (or its functional equivalent) is mandatory but a secondary component of the SCF. Secondary components provide functional support for primary components.

The attributes 710 include primitive immutable constant values for each exception type used in the SCF.

The constructors 720 provide declarations and initializations of attributes 710. Constructors must always be public. Constructors 720 are expected to leverage the initialization methods 730 in their implementations.

The initialization methods 730 provide default and/or user-defined settings for attributes 710. Initialization methods are generally public. The initialization methods 730 are also used by the constructors 720.

The access methods 740 must provide getters and setters for attributes 710. The access methods 740 must be public.

Refer to Program Listing #7 for an example of how this SecureCodingException class 700 might be implemented.

### Secure Exception Logger

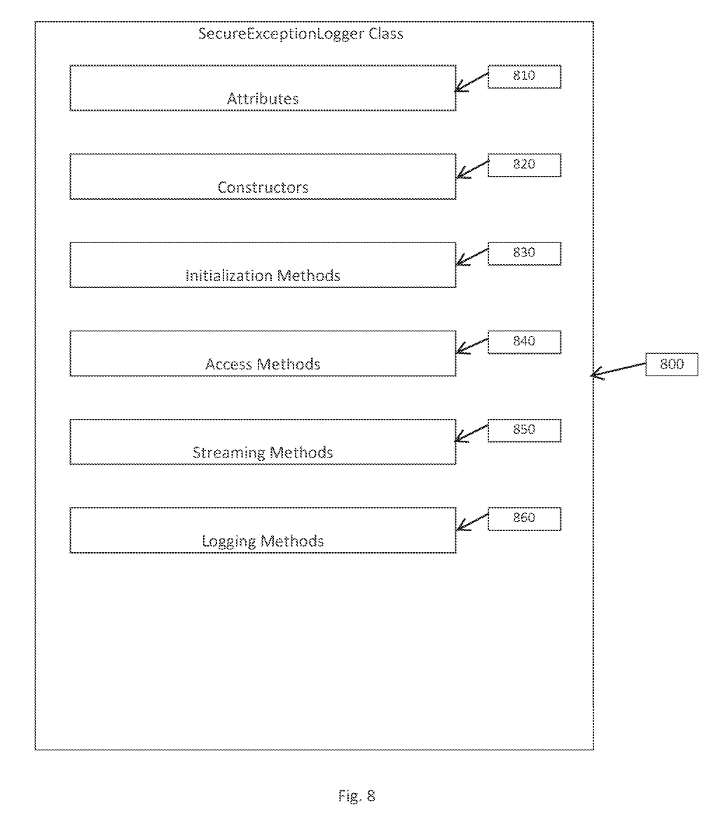

The template illustrated in FIG. 8 shows that the SecureExceptionLogger class 800 contains attributes and methods including: (a) attributes 810; (b) constructors 820; (c) initialization methods 830; (d) access methods 840; (e) streaming methods 850; and (f) logging methods 860. This class is used to log exceptions. The presence of this class and compliance with its specification (or its functional equivalent) is not a mandatory requirement of the SCF but is highly recommended. This logging capability provides a consistent approach to recording malicious attacks upon the software application. The presence of this class and compliance with its specification (or its functional equivalent) is mandatory but a secondary component of the SCF. Secondary components provide functional support for primary components.

The attributes 810 include: (a) a filename expressed as a character array (or an instance of a String class; (b) file stream; and (c) print steam.

The constructors 820 provide declarations and initializations of attributes 810. Constructors 820 must always be public. Constructors 820 are expected to leverage the initialization methods 830 in their implementations.

The initialization methods 830 provide default and/or user-defined settings for attributes 810. Initialization methods 830 are generally public. The initialization methods 830 are also used by the constructors 820.

The access methods 840 must provide getters and setters for attributes 810. The access methods 840 must be public.

The streaming methods 850 must provide file streaming and print streaming redirection in support of logging exceptions.

The logging methods 860 must provide a general capability to log exceptions.

Refer to Sequence Listing #8 for an example of how this SecureExceptionLogger class 800 might be implemented.

### Secure Exception Manager

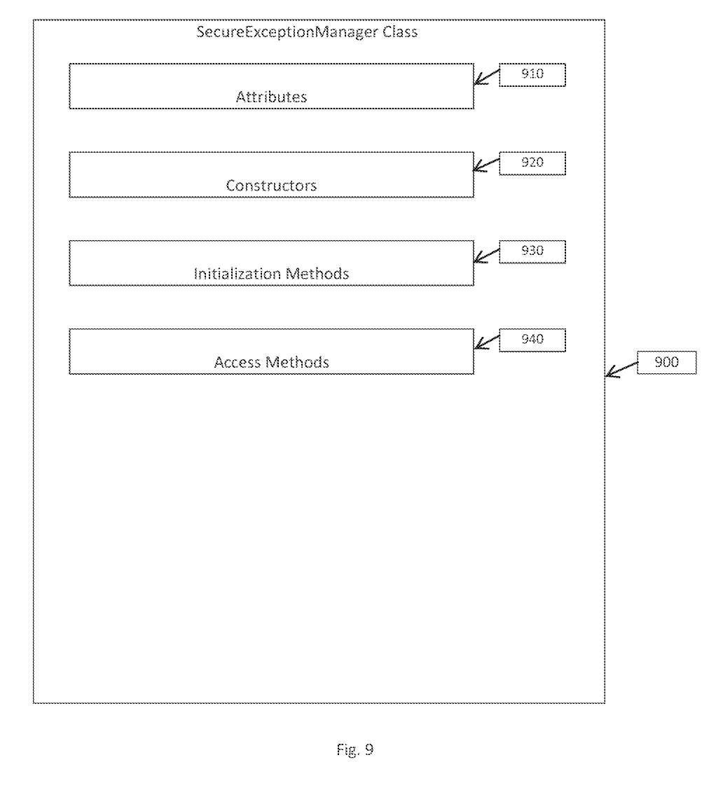

The template illustrated in FIG. 9 shows that the SecureExceptionManager class 900 contains attributes and methods including: (a) attributes 910; (b) constructors 920; (c) initialization methods 930; and (d) access methods 940. This class is used to manage exceptions in accordance with a security policy. The presence of this class and compliance with its specification (or its functional equivalent) is mandatory but a secondary component of the SCF. Secondary components provide functional support for primary components.

The attributes 910 are left to the discretion of the designer. Exception handling will vary greatly from one implementation to another.

The constructors 920 provide declarations and initializations of attributes 910. Constructors 920 must always be public. Constructors 920 are expected to leverage the initialization methods 930 in their implementations.

The initialization methods 930 provide default and/or user-defined settings for attributes 910. Initialization methods are generally public. The initialization methods 930 are also used by the constructors 920.

The access methods 940 must provide getters and setters for attributes 910. The access methods 940 must be public.

### Secure Range Checking

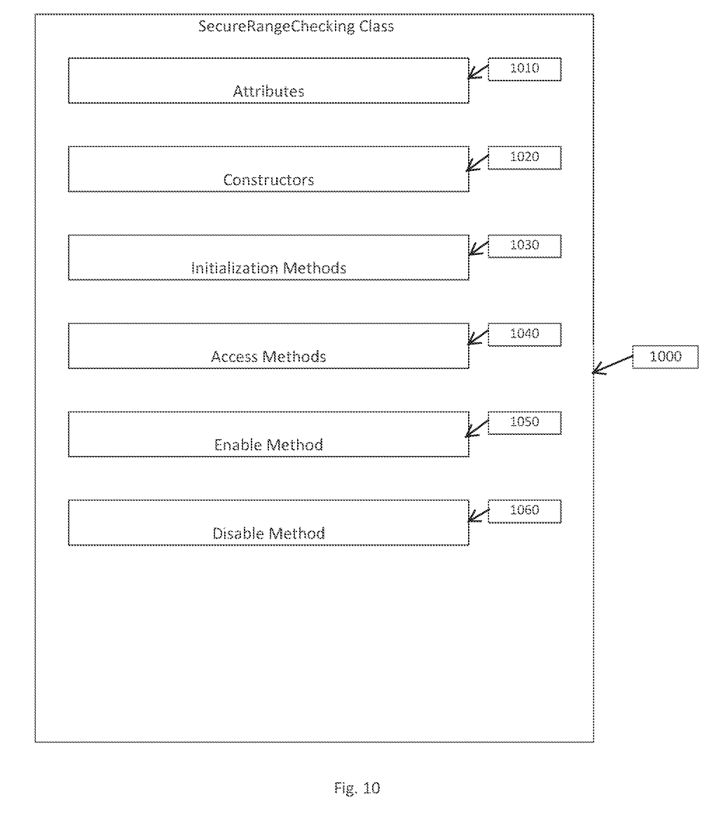

The template illustrated in FIG. 10 shows that the SecureRangeChecking class 1000 contains attributes and methods including: (a) attributes 1010; (b) constructors 1020; (c) initialization methods 1030; and (d) access methods 1040. This class is used to perform range checking required by numeric and string classes. The presence of this class and compliance with its specification (or its functional equivalent) is mandatory but a secondary component of the SCF. Secondary components provide functional support for primary components.

The attributes 1010 includes an enabled value expressed as Boolean. The status of the enabled value is either true or false. The attribute 1010 is private.

The constructors 1020 provide declarations and initializations of attributes 1010. Constructors must always be public. Constructors are expected to leverage the initialization methods in their implementations.

The initialization methods 1030 provide default and/or user-defined settings for attributes 1010. Initialization methods 1030 are generally public. The initialization methods 1030 are also used by the constructors 1020.

The access methods 1040 must provide getters and setters for attributes 1010. The access methods 1040 must be public.

The enable method 1050 toggles range checking on. The enable method 1050 must be public.

The disable method 1060 toggles range checking off. The disable method 1060 must be public.

Refer to Program Listing #10 for an example of how this SecureRangeChecking class 1000 might be implemented.

### Secure Array Index

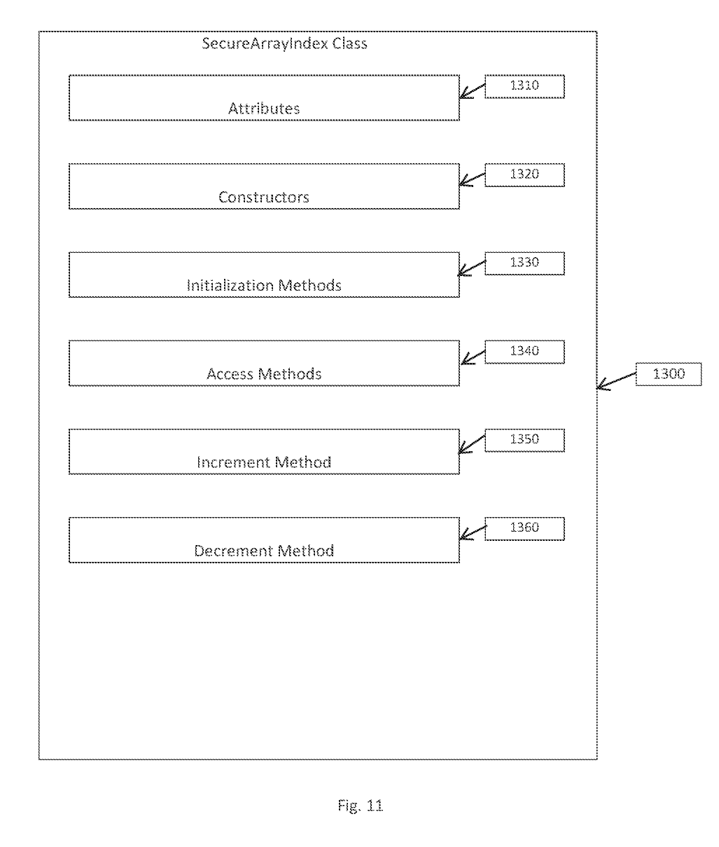

The template illustrated in FIG. 11 shows that the SecureArrayIndex class 1100 contains attributes and methods including: (a) attributes 1110; (b) constructors 1120; (c) initialization methods 1130; (d) access methods 1140; (e) increment method 1150; and (f) decrement method 1160. This class is used to represent indexes of secure arrays for both numeric and character strings. The presence of this class and compliance with its specification (or its functional equivalent) is mandatory but a secondary component of the SCF. Secondary components provide functional support for primary components.

The attributes 1110 include (a) primitive index; and (b) range expressed as an instance of a SecureArrayIndexRange class.

The constructors 1120 provide declarations and initializations of attributes 1110. Constructors must always be public. Constructors are expected to leverage the initialization methods in their implementations.

The initialization methods 1130 provide default and/or user-defined settings for attributes 1110. Initialization methods are generally public. These methods are also used by the constructors 1120.

The access methods 1140 must provide getters and setters for attributes 1110. The access methods 1140 must be public.

The increment method 1150 increases the index by 1. The increment method must be public.

The decrement method 1160 decreases the index by 1. The decrement method must be public.

Refer to Program Listing #11 for an example of how this SecureArrayIndex class 1100 might be implemented.

### Secure Array Index Range

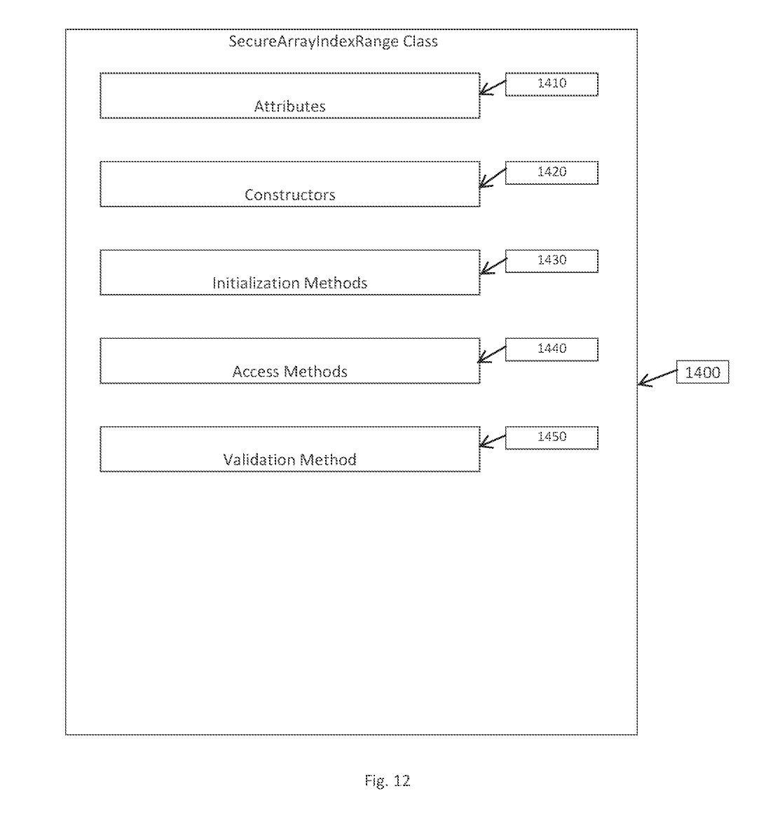

The template illustrated in FIG. 12 shows that the SecureArrayIndexRange class 1200 contains attributes and methods including: (a) attributes 1210; (b) constructors 1220; (c) initialization methods 1230; (d) access methods 1240; and (e) validation method 1150. This class provides for the definition of a valid range for the SecureArrayIndex class. The presence of this class and compliance with its specification (or its functional equivalent) is mandatory but a secondary component of the SCF. Secondary components provide functional support for primary components.

The attributes 1210 include: (a) primitive user-defined minimum value; (b) primitive user-defined maximum value; (c) primitive language-specific maximum value; and (d) primitive language-specific minimum value. The attributes (a) and (b) must be private. The attributes (c) and (d) must be immutable constants.

The constructors 1220 provide declarations and initializations of attributes 1210. Constructors must always be public. Constructors are expected to leverage the initialization methods in their implementations.

The initialization methods 1230 provide default and/or user-defined settings for attributes 1210. Initialization methods are generally public. These methods are also used by the constructors 1220.

The access methods 1240 must provide getters and setters for attributes 1410. The access methods 1440 must be public.

The validation method 1250 determines the validity of an assignment to an index with the specified range. The validation method 1250 must be public.

Refer to Program Listing #12 for an example of how this SecureArrayIndexRange class 1200 might be implemented.

Although the various embodiments illustrated in the drawings have been described as having particular features and/or combinations of components, other embodiments are possible having a combination f any features and/or components from any of the embodiments discussed above. As used in this specification, the singular forms “a”, “an”, and “the” include plural referents unless the context clearly indicates otherwise.

While the invention has been illustrated and described in detail in the drawings and foregoing description, the same is to be considered as illustrative and not restrictive in character, it being understood that all changes and modifications that come within the spirit of the invention are desired to be protected.

What is claimed is:

1. A Secure Coding Framework (SCF), a class library that employs the concept of cybersecurity through Lexical and Symbolic Proxy (CLaSP), to securely wrap and effectively replace the vulnerable primitives, operators and standard library methods of an underlying programming language, developed for any specified object-oriented programming language, comprising:
a. a secure integer class for each primitive integer data type;
b. a secure integer array class for each primitive integer data type;
c. a secure floating point class for each primitive floating point data type;
d. a secure floating point array class for each primitive floating point data type;
e. a secure string class library;
f. a secure policy class; and
g. an SCF language parser.

2. The SCF of claim 1, wherein said secure integer class of 1(a) comprise:
a. a private primitive integer attribute;
b. a default constructor without range constraints;
c. a constructor with user-defined range constraints;
d. an access method that returns a value of a secure data type;
e. an access method that returns a value of a primitive data type;
f. a secure integer method for each valid operator; and
g. a secure integer method for each valid type conversion.

3. The SCF of claim 1, wherein said secure integer array class of 1(b) further comprise:
a. a private primitive integer array attribute;
b. a constructor that fixes a number of dimensions for an array;
c. a secure method to initialize all elements of the array;
d. a secure method to set an indexed element of the array; and
e. a secure method to get an indexed element of the array.

4. The SCF of claim 3, further comprising:
a. an exception handling routine for attempts to access an invalid integer index.

5. The SCF of claim 1, wherein said secure floating point class of 1(c) further comprise:
a. a private primitive floating point attribute;
b. an access method that returns secure data type;
c. an access method that returns primitive data type;
d. a default constructor without range constraints;
e. a constructor with user-defined range constraints;
f. a secure floating point method for each valid operator; and
g. a secure floating point method for each valid type conversion.

6. The SCF of claim 1, wherein said secure floating point array class of 1(d) further comprise:
a. a private primitive array attribute;
b. a constructor that fixes a number of dimensions for an array;
c. a secure method to initialize all elements of the array;
d. a secure method to set an indexed element of the array; and
e. a secure method to get an indexed element of the array.

7. The SCF of claim 6, wherein said secure methods of claim 6(d)-6(e) further comprise:
a. an exception handling routine for attempts to access an FP index outside of its dimensions.

8. The SCF of claim 2, wherein said secure integer methods of 2(f)-2(g) further comprise:
a. an exception handling routine for user-defined range constraint violations;
b. an exception handling routine for integer overflow;
c. an exception handling routine for integer underflow; and
d. an exception handling routine for loss of sign, magnitude and/or precision in type conversions.

9. The SCF of claim 5, wherein said secure floating point methods of 5(f) and 5(g) further comprise:
a. an exception handling routine for user-defined range constraint violations;
b. an exception handling routine for floating point floors;
c. an exception handling routine for floating point ceilings; and
d. an exception handling routine for loss of sign, magnitude and/or precision in type conversions.

10. The SCF of claim 1, wherein said secure string class library of 1(e) further comprise:
a. a secure string class for structured query language (SQL) character strings;
b. a secure string class for uniform resource identifier (URL) character strings;
c. a secure string class for rule-based password character strings;
d. a secure string class for lightweight directory access protocol (LDAP) character strings;
e. a secure string class for XML path (Xpath) character strings;
f. a secure string class for eXtensible Stylesheet Language Transformation (XSLT) character strings;
g. a secure string class for file system filename character strings; and
h. a secure string class for file system pathname character strings.

11. The SCF of claim 10, wherein said secure string class of 10(a)-10(h) further comprise:
a. a private string attribute;
b. a default constructor without limits on a maximum number of characters in an underlying string;
c. a constructor with user-defined limits on the maximum number of characters in the underlying string;
d. an access method that returns a secure character string data type;
e. an access method that returns a primitive character string data type;
f. a secure string method for blacklisting characters of the underlying string;
g. a secure string method for whitelisting characters of the underlying string;
h. a secure string method for blacklisting character string sequences of the underlying string; and
i. a secure string method for whitelisting character string sequences of the underlying string.

12. The SCF of claim 11, wherein said cecure string methods of 11(f)-11(i) further comprise:
a. an exception handling routine for user-defined limits on the number of characters in the underlying string;
b. an exception handling routine for attempts to violate the allowable character content of the underlying string; and
c. an exception handling routine for attempts to violate the allowable string content of the underlying string.

13. The SCF of claim 1, wherein said secure policy class of 1(f) further comprise:
a. an exception handling method for defining a default response to a type of exception encountered at run-time; and
b. an exception handling method to override the default response to a type of exception encountered at run-time.
